(19) United States
(12) Patent Application Publication
(10) Pub. No.: US 2026/0152950 A1
(43) Pub. Date: Jun. 4, 2026

(54) TENT BEAM SKELETON FOR OUTDOOR LOUVER TENT AND OUTDOOR LOUVER TENT

(71) Applicant: Linhai Chiyang Leisure Products Co., Ltd., Zhejiang (CN)

(72) Inventor: Linwan Liu, Zhejiang (CN)

(73) Assignee: Linhai Chiyang Leisure Products Co., Ltd., Zhejiang (CN)

(21) Appl. No.: 18/685,900

(22) PCT Filed: Oct. 27, 2023
(86) PCT No.: PCT/CN2023/126994

§ 371 Date: Feb. 23, 2024

(30) Foreign Application Priority Data
Sep. 4, 2023 (CN) 202322384683.2

(51) Int. Cl. E04F 10/10; E04F 17/00; F21V 33/00

(52) U.S. Cl. CPC E04F 10/10; E04F 17/00; F21V 33/006

(57) ABSTRACT

The present invention discloses a tent beam skeleton for outdoor louver tent and an outdoor louver tent. The tent beam skeleton for outdoor louver tent includes a tent skeleton and a louver tent roof. The tent skeleton includes a tent beam frame and a plurality of support columns for supporting the tent beam frame, and the louver tent roof is configured to be fitted with the tent beam frame. The tent beam frame includes end edge tent beams, side edge tent beams and fixed bases. The louver tent roof includes a plurality of louver board units. Two ends of each of the louver board units are respectively configured to be fitted and mounted with the tent beam frame. By adopting a horizontal and vertical through-type fixing structure, stability of mounting is improved, and by adopting built-in mounting and fixation, components are prevented from being affected by environmental factors.

### TECHNICAL FIELD

The present invention relates to the technical field of outdoor louver tents, and in particular to a tent beam skeleton for outdoor louver tent and an outdoor louver tent.

### RELATED ART

There are a variety of structural forms of outdoor tents, such as folding tents that can be folded, and fixed tents that can be directly placed in outdoor courtyards and parks. A louver tent, as a type of fixed tent, has a louver roof. The louvers can flip by using a linkage mechanism, so as to be opened or closed to function as a sunshade. The louver tent is very popular among consumers because of its ability to adjust light.

The existing tent skeleton in the louver tent on the market is usually formed by fixedly assembling a ring beam and leg tubes. The tent skeleton needs to have good stability since it is usually used in an outdoor environment and needs to withstand strong wind, heavy rain and heavy snow. In the existing louver tent, the upright column and the crossbeam are connected through a lap joint or a corner fitting, which is not firm in connection and leads to a low stability in use. Moreover, parts at the joints are usually exposed and susceptible to erosion by the external environment, which affects the service life.

In the existing louver tent, the linkage mechanism is usually a linkage strip. The linkage strip is disposed along an arrangement direction of louver boards, and linked with the louver boards through a connecting mechanism. However, the existing linkage strip is mounted to the louver boards in a complicated structure, which enhances the overall difficulty of assembling the louver boards.

### SUMMARY OF INVENTION

In view of the above problems, the present invention aims to provide a tent beam skeleton for outdoor louver tent and an outdoor louver tent. By adopting a horizontal and vertical through-type fixing structure, stability of mounting is improved, and by adopting built-in mounting and fixation, components are prevented from being affected by environmental factors, thereby improving a service life. Louver boards and a linkage strip can be assembled and mounted conveniently and quickly, thereby improving assembly efficiency.

### Solution to Problem

In order to solve the technical problems of the present invention, the following technical solution may be adopted:

A tent beam skeleton for outdoor louver tent includes a tent skeleton and a louver tent roof. The tent skeleton includes a tent beam frame and a plurality of support columns for supporting the tent beam frame, and the louver tent roof is configured to be fitted with the tent beam frame. The tent beam frame includes end edge tent beams, side edge tent beams and fixed bases. The fixed bases are configured to connect the end edge tent beams and the side edge tent beams. Each of the fixed bases is provided with vertical lock holes and horizontal lock holes. The vertical lock holes are provided in a mounting platform of the fixed base. The fixed base is provided with locking reinforcement seats. The horizontal lock holes are located in the locking reinforcement seats. Fasteners are respectively fixedly mounted to the vertical lock holes and the horizontal lock holes by running through the end edge tent beams and the side edge tent beams.

A lower part of the fixed base is provided with an embedment seat, and the embedment seat is fixedly mounted to an upper end of the support column. An inner wall of the support column is provided with a reinforcing embedment groove and a reinforcing clamping strip, and the embedment seat is provided with an embedment clamping strip and an embedment clamping groove. The embedment clamping strip is configured to be fitted and mounted with the reinforcing embedment groove, and the embedment clamping groove is configured to be fitted and mounted

The fixed base includes a first side wall and a second side wall, and the first side wall and the second side wall are disposed adjacent to each other. Opposite surfaces of the first side wall and the second side wall are respectively provided with a first tent beam groove and a second tent beam groove, and a limit boss is disposed between the first tent beam groove and the second tent beam groove.

Inner side surfaces of the first side wall and the second side wall are respectively provided with the locking reinforcement seat, and the locking reinforcement seat is provided with at least two horizontal lock holes spaced apart along a vertical direction.

Two ends of the side edge tent beam are respectively provided with a first tent beam mounting portion, and the first tent beam mounting portion is configured to be correspondingly fitted with the first tent beam groove. The first tent beam mounting portion is provided with first horizontal butting holes and first vertical butting holes, and the first horizontal butting holes and the first vertical butting holes are all through hole structures.

Two ends of the end edge tent beam are respectively provided with a second tent beam mounting portion, and the second tent beam mounting portion is configured to be correspondingly fitted with the second tent beam groove. The second tent beam mounting portion is provided with second horizontal butting holes and second vertical butting holes, and the second horizontal butting holes and the second vertical butting holes are all through hole structures.

The side edge tent beam is provided with a first drainage groove, and the end edge tent beam is provided with a second drainage groove. End portions of the first drainage groove and the second drainage groove are adjacent to a water leakage opening in the mounting platform. The side edge tent beam is provided with a mounting beam body. The mounting beam body is configured to be fitted and mounted with the louver tent roof.

The end edge tent beams or/and the side edge tent beams are each formed by butting two tent beam units. A butt joint of the two tent beam units is provided with a receiving base. One part of an inner cavity of the receiving base is in an inner cavity of the tent beam unit at one end, and the other part of the inner cavity is in an inner cavity of the tent beam unit at the other end.

The receiving base includes a side receiving seat and an upper receiving seat. The side receiving seat is provided with a plurality of side fastening holes. The upper receiving seat is provided with a plurality of upper fastening holes. An end portion of the tent beam unit is provided with a receiving end. A side wall of the receiving end is provided with side butting holes. An upper surface of the receiving end is provided with upper butting holes. The side butting holes are configured to be correspondingly fitted with the side fastening holes, and the upper butting holes are configured to be correspondingly fitted with the upper fastening holes.

An outdoor louver tent includes the tent beam skeleton according to any of the above. A louver tent roof includes a plurality of louver board units. Two ends of each of the louver board units are respectively configured to be fitted and mounted with the tent beam frame. The louver board units each include a louver board, a first end cover disposed at one end of the louver board, a second end cover disposed at the other end of the louver board and a louver rotating shaft fitted with the tent beam frame. The first end cover or/and the second end cover is/are provided with a clamping seat. The clamping seat is fixedly fitted with a linkage seat, and the linkage seat is configured to be fitted and mounted with a linkage strip.

The clamping seat is disposed on the first end cover, and the first end cover includes a first louver fixing portion, a first end cover portion and the clamping seat disposed on an outer side wall of the first end cover portion. The clamping seat is provided with a clamping fixing hole. The linkage seat is provided with a clamping groove. The clamping seat is embedded in the clamping groove. An embedment fixing hole is provided in the clamping groove. The clamping fixing hole and the embedment fixing hole are aligned with each other.

The linkage seat is provided with a first louver shaft hole. One end of the louver rotating shaft is fitted and mounted with the first louver shaft hole, and the other end of the louver rotating shaft extends outwards to be fitted and mounted with the tent beam frame.

The second end cover includes a second louver fixing portion, a second end cover portion and a second louver shaft hole. One end of the louver rotating shaft is configured to be fitted and mounted with the second louver shaft hole, and the other end of the louver rotating shaft extends outwards to be fitted and mounted with the tent beam frame.

The second end cover has a same structure as the first end cover, and the second end cover is fitted and mounted with the linkage seat through the clamping seat.

A bottom surface of the louver board is provided with a light bar groove cavity.

The tent skeleton is further fitted with a roller shutter mechanism. The roller shutter mechanism includes a roller shutter frame and roller shutters disposed in the roller shutter frame, and the roller shutter frame is fitted and mounted with the tent skeleton. The roller shutter frame includes a side slide rail rack and an upper roller shutter rack. The roller shutters are rollable into the upper roller shutter rack.

The side slide rail rack is mounted on a side wall of a support column in the tent skeleton, and two ends of the upper roller shutter rack are respectively fixedly fitted with the side wall of the support column through a roller shutter end cover plate. A bottom of the tent beam frame is provided with mating grooves, and an upper part of the upper roller shutter rack is provided with mating strips. The mating strips are fitted and mounted with the mating grooves.

The roller shutters each include a roller shutter body, a roller shutter shaft, roller shutter mounting seats located at two ends of the roller shutter shaft, and a roller shutter rod located at a bottom end of the roller shutter body. The roller shutter mounting seats are fitted and mounted with the roller shutter end cover plates.

The clamping seat includes a clamping seat body and alignment seats disposed at two sides of the clamping seat body, and the clamping groove includes a clamping groove body and alignment grooves disposed at two sides of the clamping groove body. The clamping seat body is correspondingly fitted with the clamping groove body, and the alignment seats are correspondingly fitted with the alignment grooves.

One end of the linkage seat is provided with a linkage shaft hole, the linkage shaft hole is fitted and mounted with the linkage strip through a linkage rotating shaft, the linkage strip is fitted with a linkage swing arm, the other end of the linkage swing arm is driven to swing by a driving shaft, and the driving shaft is fitted and mounted with a turbine seat or a motor.

The clamping seat and the clamping groove are interchangeable.

A lower part of the turbine seat is fitted with a turbine drive seat. The turbine drive seat is configured to be fitted with an operating rod, and a rod embedment groove is provided in the turbine drive seat. The rod embedment groove includes an entrance/exit groove, a transposition groove and a limit groove, and an upper end of the operating rod is provided with an embedment rod. The embedment rod is capable of moving upward along the entrance/exit groove into the limit groove through the transposition groove to complete a rotational fit between the operating rod and the turbine drive seat.

### Effects of Invention

Compared with the prior art, the present invention has the following beneficial effects: By optimizing the design of the fixed bases, the fasteners are fixed with the vertical lock holes and the horizontal lock holes by directly running through the side edge tent beams and the end edge tent beams, so that horizontal and vertical through-type fixed mounting is realized, thereby improving the stability of mounting. By adopting the built-in fastening and mounting structure, fixed components are prevented from being exposed, so that the appearance is more aesthetic, and the components are prevented from being affected by environmental factors, thereby improving the service life. The structure of the fixed bases is optimized, which facilitates the assembly and mounting of the side edge tent beam, the end edge tent beams and the support columns, makes it more convenient to mount the tent skeleton and improves the stability and service life of the tent skeleton. In addition, by optimizing the design of the clamping seat, the linkage seat can be quickly fitted and mounted with the first end cover or/and the second end cover in the louver board, so that the louver board unit can be quickly assembled and mounted with the linkage strip, and conveniently fitted and mounted with the tent beam frame, thereby making the mounting more convenient. The roller shutter mechanism added facilitates the formation of the internal independent space, which improves the service performance.

The characteristics of the present invention can be clearly understood by referring to the drawings of the present invention and the detailed description of the preferred implementations below.

### BRIEF DESCRIPTION OF DRAWINGS

FIG. 1 is a schematic view showing an overall structure of an outdoor louver tent according to the present invention;

FIG. 2 is a schematic view showing a mounting structure of a tent skeleton according to the present invention;

FIG. 3 is a schematic structural view of a side edge tent beam according to the present invention;

FIG. 4 is a schematic structural view of an end edge tent beam according to the present invention;

FIG. 5 is a schematic structural view of a fixed base according to the present invention;

FIG. 6 is a schematic cutaway view showing a mounting structure of a side edge tent beam and vertical lock holes according to the present invention;

FIG. 7 is a schematic cutaway view showing a mounting structure of an end edge tent beam and vertical lock holes according to the present invention;

FIG. 8 is a schematic cutaway view showing a mounting structure of a side edge tent beam and horizontal lock holes according to the present invention;

FIG. 9 is a schematic cutaway view showing a mounting structure of an end edge tent beam and horizontal lock holes according to the present invention;

FIG. 10 is a schematic cutaway view showing a mounting structure of an embedment seat and a support column according to the present invention;

FIG. 11 is a schematic view showing a butting and mounting structure of a tent beam unit according to the present invention;

FIG. 12 is a schematic exploded structural view of a tent beam unit and a receiving base according to the present invention;

FIG. 13 is a schematic cutaway view showing a mounting structure of a tent beam unit and a receiving base according to the present invention;

FIG. 14 is a schematic structural view of an outdoor louver tent whose louvers are opened according to the present invention;

FIG. 15 is a schematic structural view of an outdoor louver tent whose louvers are closed according to the present invention;

FIG. 16 is a schematic view showing a driving structure of a linkage strip according to the present invention;

FIG. 17 is a schematic view showing a mounting structure of a side edge tent beam and a louver board unit according to the present invention;

FIG. 18 is a schematic cutaway view I showing a mounting structure of a side edge tent beam and a louver board unit according to the present invention;

FIG. 19 is a schematic cutaway view II showing a mounting structure of a side edge tent beam and a louver board unit according to the present invention;

FIG. 20 is a schematic view showing a mounting structure of a louver board, a first end cover and a linkage seat according to the present invention;

FIG. 21 is a schematic view showing a mounting structure of a louver board and a second end cover according to the present invention;

FIG. 22 is a schematic structural view of a second end cover according to the present invention;

FIG. 23 is a schematic cutaway structural view of a louver board according to the present invention;

FIG. 24 is a schematic view showing a mounting structure of a first end cover and a linkage seat according to the present invention;

FIG. 25 is a schematic cutaway view showing a mounting structure of a first end cover and a linkage seat according to the present invention;

FIG. 26 is a schematic structural view of a first end cover according to the present invention;

FIG. 27 is a schematic structural view of a linkage seat according to the present invention;

FIG. 28 is a schematic view showing an overall structure of a roller shutter mechanism according to the present invention;

FIG. 29 is a schematic cutaway view showing a mounting structure of a roller shutter mechanism and a tent skeleton according to the present invention;

FIG. 30 is a schematic cutaway view showing a mounting structure of a side slide rail rack and a support column according to the present invention;

FIG. 31 is a schematic exploded structural view of a roller shutter mechanism according to the present invention;

FIG. 32 is a schematic structural view of a turbine drive seat according to the present invention;

FIG. 33 is a schematic structural view of an embedment rod according to the present invention; and

FIG. 34 is a schematic view showing a fitting and mounting structure of a turbine seat and an operating rod according to the present invention.

### DESCRIPTION OF EMBODIMENTS

In order to make the technical means, inventive features, objectives and effects of the present invention easily understood, the present invention will be further explained with reference to specific drawings.

It should be noted that all the directional indications (such as on, under, left, right, front, rear, . . . ) in the embodiments of the present invention are used merely to explain the relative position relationship, movement, etc. between the components in a particular attitude (as shown in the accompanying drawings), and if the particular attitude changes, the directional indications change accordingly. In addition, the terms “first” and “second” involved in the present invention are merely used for descriptive purposes, and cannot be understood as indicating or implying relative importance or implicitly indicating the number of technical features indicated. Thus, the features defined with “first” and “second” may explicitly or implicitly include at least one such feature.

### Embodiment 1

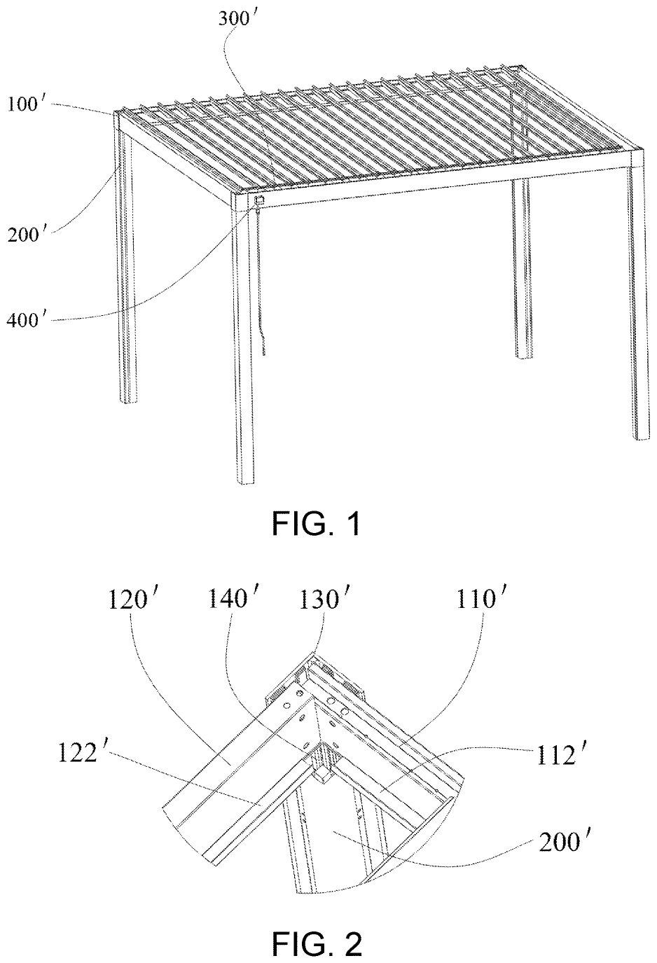

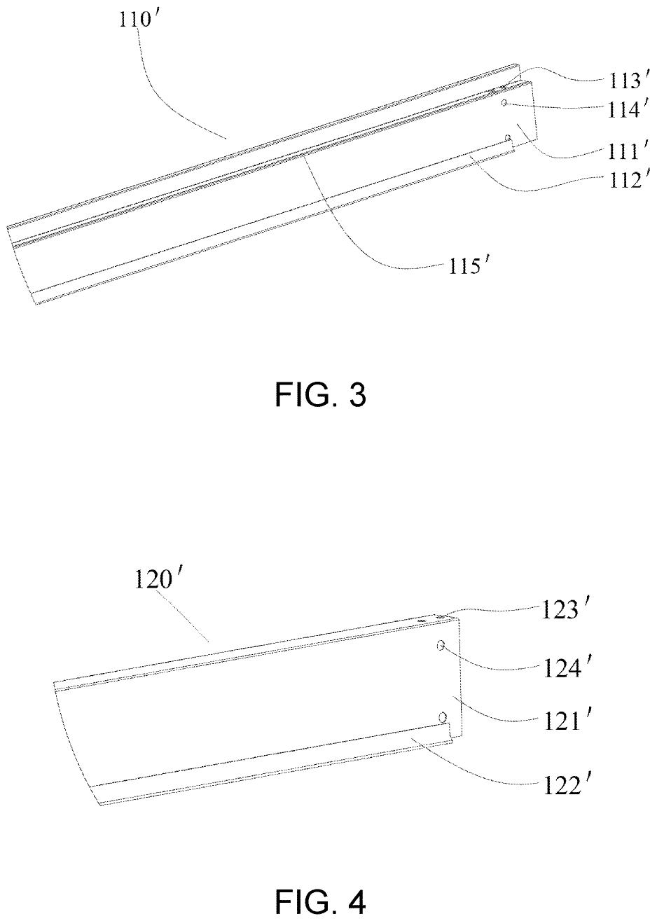

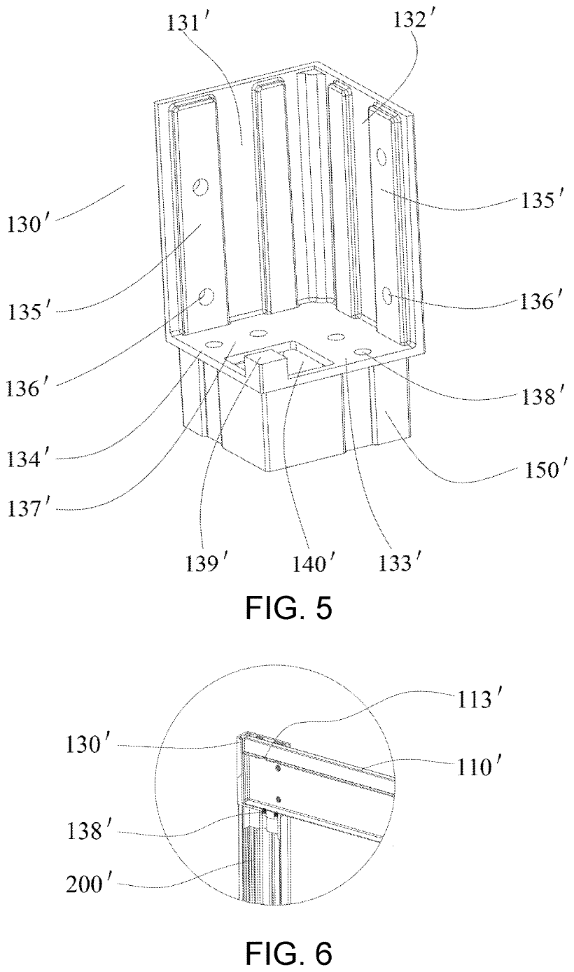

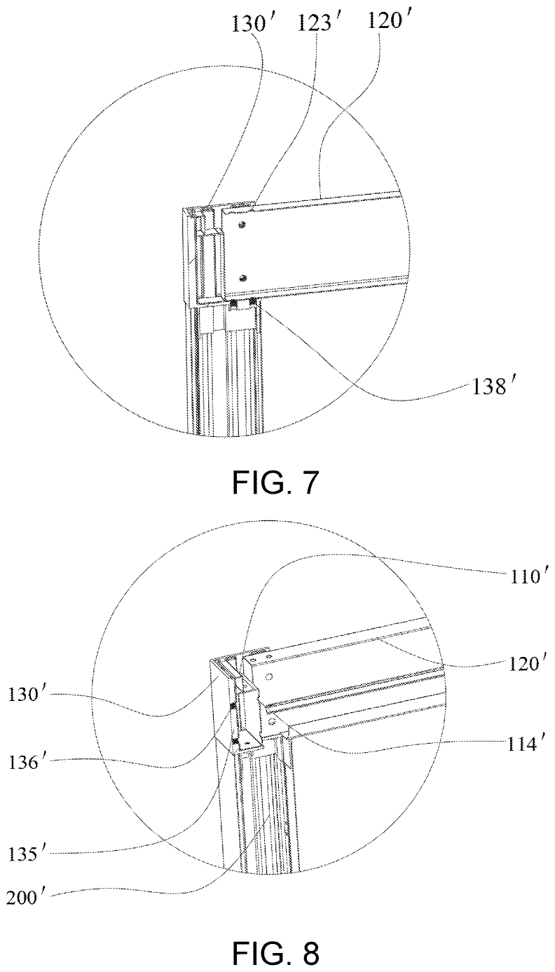

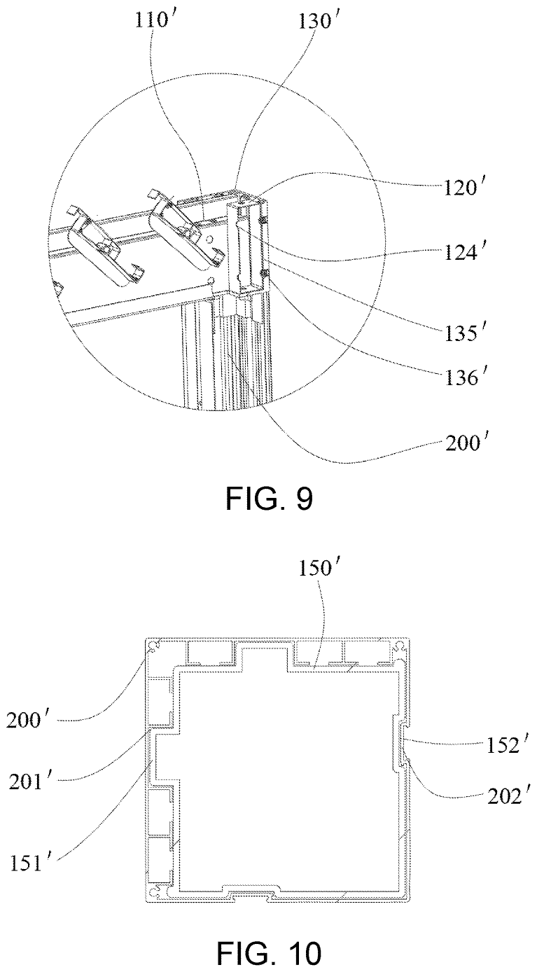

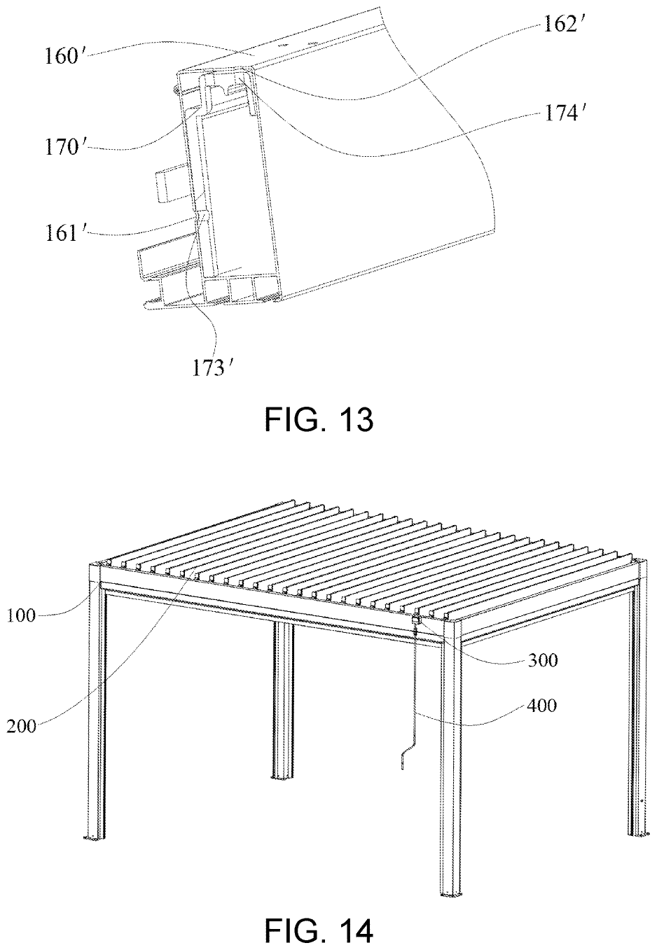

As shown in FIG. 1 to FIG. 13, a tent beam skeleton for outdoor louver tent provided by this embodiment includes a tent skeleton 100′ and a louver tent roof 300′. The tent skeleton 100′ includes a tent beam frame and a plurality of support columns 200′ for supporting the tent beam frame, and the louver tent roof 300′ is configured to be fitted with the tent beam frame. According to different specifications of the louver tent roof 300′, the louver tent roof can be fitted and mounted with the tent beam frame through different structures. In addition, according to specifications of the louver tent, the number of the support columns 200′ may be 2, 3, 4, 6, etc. In a preferred embodiment, the number of the support columns 200′ is 4. The louver tent roof usually includes a plurality of louver boards. Part of the louver boards may be light-transparent boards, sunlight boards, or sunshade boards or aluminum boards, which can be flipped by means of a linkage member, such as a linkage strip, in combination with a turbine mechanism 400′.

The tent beam frame includes end edge tent beams 120′, side edge tent beams 110′ and fixed bases 130′. The numbers of the end edge tent beams 120′ and the side edge tent beams 110′ are preferably 2 respectively. According to different specifications of the louver tent, the number of the end edge tent beams 120′ may be 3, and the number of the side edge tent beams 110′ may be 4, so as to form a louver tent with two tent roof structures. According to different specification demands, other combinations may also be built. In this embodiment, the numbers of the end edge tent beams 120′ and the side edge tent beams 110′ are preferably 2 respectively to form a square frame structure. The fixed bases 130′ are configured to connect the end edge tent beams 120′ and the side edge tent beams 110′. Each of the fixed bases 130′ is provided with vertical lock holes 138′ and horizontal lock holes 136′. The vertical lock holes 138′ are provided in a mounting platform 137′ of the fixed base 130′. Preferably, the vertical lock hole 138′ usually has a hole cavity with a certain depth, which is preferably more than 2 cm. The vertical lock hole can extend downward relative to a bottom surface of the mounting platform 137′ so as to improve the stability of mounting when butted with a fastener. The fixed base 130′ is provided with locking reinforcement seats 135′. The horizontal lock holes 136′ are located in the locking reinforcement seats 135′. The locking reinforcement seat 135′ may be a plate structure or an independent lock hole seat structure to increase a depth of a hole cavity of the horizontal lock hole 136′, which facilitates fixation and locking with the fastener and improves the stability of mounting. Fasteners are respectively fixedly mounted to the vertical lock holes 138′ and the horizontal lock holes 136′ by running through the end edge tent beams 120′ and the side edge tent beams 110′. The fasteners are fixed with the vertical lock holes 138′ and the horizontal lock holes 136′ by directly running through the side edge tent beams 110′ and the end edge tent beams 120′. The fasteners are preferably fastening bolts so as to realize horizontal and vertical through-type fixed mounting, thereby improving the stability of mounting.

A lower part of the fixed base 130′ is provided with an embedment seat 150′, and the embedment seat 150′ is fixedly mounted to an upper end of the support column 200′. An inner wall of the support column 200′ is provided with a reinforcing embedment groove 201′ and a reinforcing clamping strip 202′, and the embedment seat 150′ is provided with an embedment clamping strip 151′ and an embedment clamping groove 152′. The embedment clamping strip 151′ is configured to be fitted and mounted with the reinforcing embedment groove 201′, and the embedment clamping groove 152′ is configured to be fitted and mounted with the reinforcing clamping strip 202′. The embedment seat 150′ is adopted to complete the fixed mounting structure with the support column 200′. The reinforcing embedment groove 201′ and the reinforcing clamping strip 202′ are preferably distributed on four inner walls of the support column, and the embedment clamping strip 151′ and the embedment clamping groove 152′ are preferably distributed on four side walls of the embedment seat 150′. By using the clamping and embedment mounting structure, good butting and fixation can be formed, thereby reducing the locking of the fasteners, making the mounting more convenient, and ensuring the stability of mounting. A depth of the embedment seat 150′ is preferably at least 5 cm.

In a specific structure of this embodiment, the fixed base 130 includes a first side wall 131′ and a second side wall 132′, and the first side wall 131′ and the second side wall 132′ are disposed adjacent to each other. Opposite surfaces of the first side wall 131′ and the second side wall 132′ are respectively provided with a first tent beam groove 133′ and a second tent beam groove 134′, and a limit boss 139′ is disposed between the first tent beam groove 133′ and the second tent beam groove 134′. The first side wall 131′ and the second side wall 132′ are disposed on outer sides. Outer wall surfaces of the first side wall 131′ and the second side wall 132′ are usually smooth surfaces, and inner side surfaces of the first side wall 131′ and the second side wall 132′ are respectively provided with the locking reinforcement seat 135′. The locking reinforcement seat 135′ is provided with at least two horizontal lock holes 136′ spaced apart along a vertical direction, and the horizontal lock holes 136′ are each in a blind hole structure. In another equivalent embodiment, the two horizontal lock holes 136′ may be distributed corresponding to the two locking reinforcement seats 135′, and spaced apart as a whole along the vertical direction. The horizontal lock holes 136′ are each in the blind hole structure, which can prevent the fasteners butted therewith from being exposed. The fastener is an inside-out fixing structure to form a built-in mounting structure that prevents the fixed component from being exposed, which can make the appearance more aesthetic and prevent the component from being affected by environmental factors, thereby improving the service life.

Two ends of the side edge tent beam 110′ are respectively provided with a first tent beam mounting portion 111′, and the first tent beam mounting portion 111′ is configured to be correspondingly fitted with the first tent beam groove 133′, which facilitates butting and mounting. The first tent beam mounting portion 111′ is provided with first horizontal butting holes 114′ and first vertical butting holes 113′, and the first horizontal butting holes 114′ and the first vertical butting holes 113′ are all through hole structures. The fasteners are respectively fixedly fitted with the horizontal lock hole 136′ and the vertical lock hole 138′ in corresponding positions by running through the first horizontal butting hole 114′ and the first vertical butting hole 113′. Preferably, the horizontal lock hole 136′ of the first side wall 131′ and the vertical lock hole 138′ in the mounting platform 137′ adjacent to the first side wall 131′ are configured to be correspondingly mounted with the first horizontal butting hole 114′ and the first vertical butting hole 113′.

Two ends of the end edge tent beam 120′ are respectively provided with a second tent beam mounting portion 121′, and the second tent beam mounting portion 121′ is configured to be correspondingly fitted with the second tent beam groove 134′, which facilitates butting and mounting. The second tent beam mounting portion 121′ is provided with second horizontal butting holes 124′ and second vertical butting holes 123′, and the second horizontal butting holes 124′ and the second vertical butting holes 123′ are all through hole structures. The fasteners are respectively fixedly fitted with the vertical lock hole 138′ and the horizontal lock hole 136′ in corresponding positions by running through the second horizontal butting hole 124′ and the second vertical butting hole 123′. Preferably, the horizontal lock hole 136′ of the second side wall 132′ and the vertical lock hole 138′ in the mounting platform 137′ adjacent to the second side wall 132′ are configured to be correspondingly mounted with the second horizontal butting hole 124′ and the second vertical butting hole 123′.

In a preferred embodiment, the side edge tent beam 110′ is provided with a first drainage groove 112′, and the end edge tent beam 120′ is provided with a second drainage groove 122′. End portions of the first drainage groove 112′ and the second drainage groove 122′ are adjacent to a water leakage opening 140′ in the mounting platform 137′, which facilitates the formation of a drainage system and the hidden drainage of the louver tent.

In a specific structure, the side edge tent beam is provided with a mounting beam body 115′. The mounting beam body 115′ is configured to be combined with other connecting components such as a cover plate so as to be fitted and mounted with the louver tent roof 300′. Specifically, the mounting beam body is configured to assist in hinging and fixed mounting of the louver board and also to be fitted and mounted with components such as a turbine worm and a linkage strip. In addition, the mounting beam body may also be used for mounting a drive motor in combination with structures such as a telescopic rod so as to make the louver board flip.

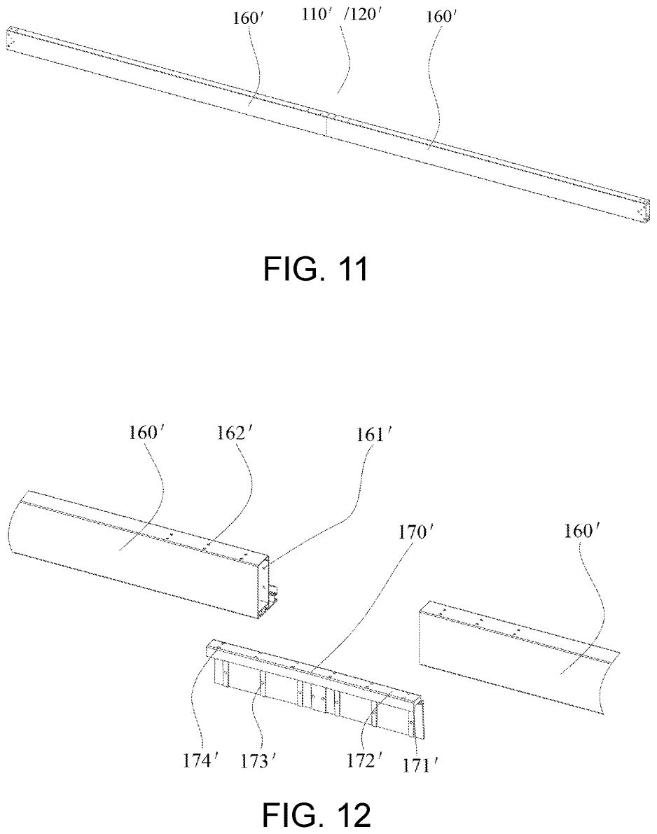

In a preferred embodiment, as shown in FIG. 11 to FIG. 13, the end edge tent beams 120′ or/and the side edge tent beams 110′ are each formed by butting two tent beam units 160′, which can reduce the overall length and the packaging volume. A butt joint of the two tent beam units 160′ is provided with a receiving base 170′. One part of an inner cavity of the receiving base 170′is in an inner cavity of the tent beam unit 160′ at one end, and the other part of the inner cavity is in an inner cavity of the tent beam unit 160′ at the other end. By adopting the embedment assembly structure, the stability of mounting at the joint is improved. The receiving base 170′ includes a side receiving seat 171′ and an upper receiving seat 172′. The side receiving seat 171′ is provided with a plurality of side fastening holes 173′. The upper receiving seat 172 is provided with a plurality of upper fastening holes 174′. An end portion of the tent beam unit 160′ is provided with a receiving end. A side wall of the receiving end is provided with side butting holes 161′. An upper surface of the receiving end is provided with upper butting holes 162′. The side butting holes 161′ are configured to be correspondingly fitted with the side fastening holes 173′, and the upper butting holes 162′ are configured to be correspondingly fitted with the upper fastening holes 174′. By optimizing the structure of the receiving base 170′, the receiving base can be butted and fixedly mounted with the tent beam unit 160′ conveniently, which makes the assembly more convenient.

The upper butting holes 162′ and the side butting holes 161′ are all threaded holes with internal threads, so that the fasteners can be threadedly fastened and butted directly through the upper fastening holes 174′ and the side fastening holes 173′. The upper butting holes 162′ and the side butting holes 161′ are all threaded hole structures with a certain stroke, which improves the stability of fixation.

By optimizing the design of the fixed bases, the fasteners are fixed with the vertical lock holes and the horizontal lock holes by directly running through the side edge tent beams and the end edge tent beams, so that horizontal and vertical through-type fixed mounting is realized, thereby improving the stability of mounting. By adopting the built-in fastening and mounting structure, fixed components are prevented from being exposed, so that the appearance is more aesthetic, and the components are prevented from being affected by environmental factors, thereby improving the service life. The structure of the fixed bases is optimized, which facilitates the assembly and mounting of the side edge tent beam, the end edge tent beams and the support columns, makes it more convenient to mount the tent skeleton and improves the stability and service life of the tent skeleton.

### Embodiment 2

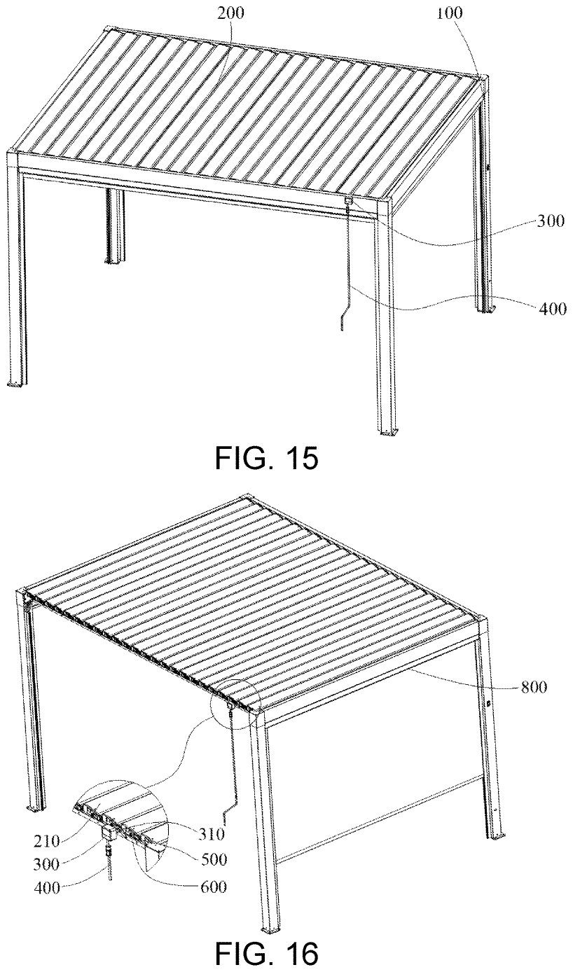

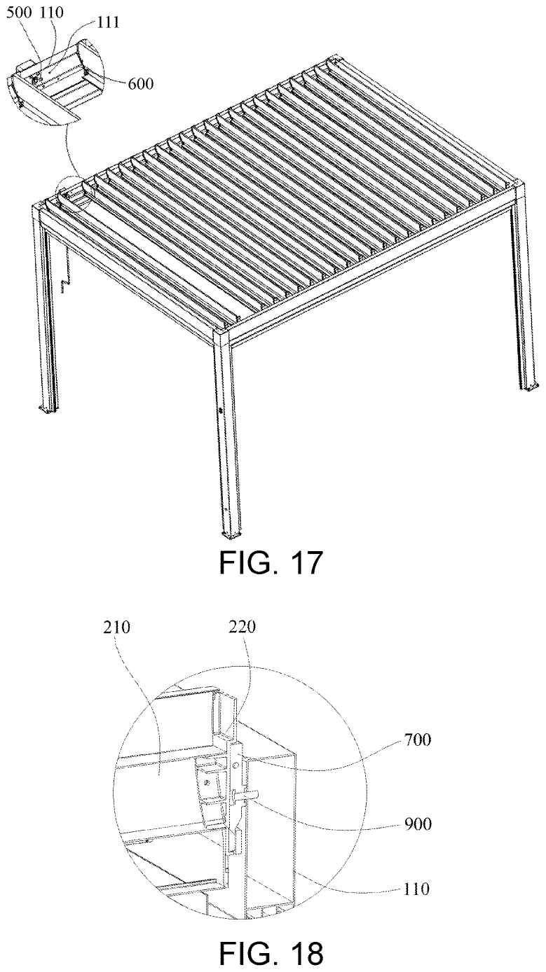

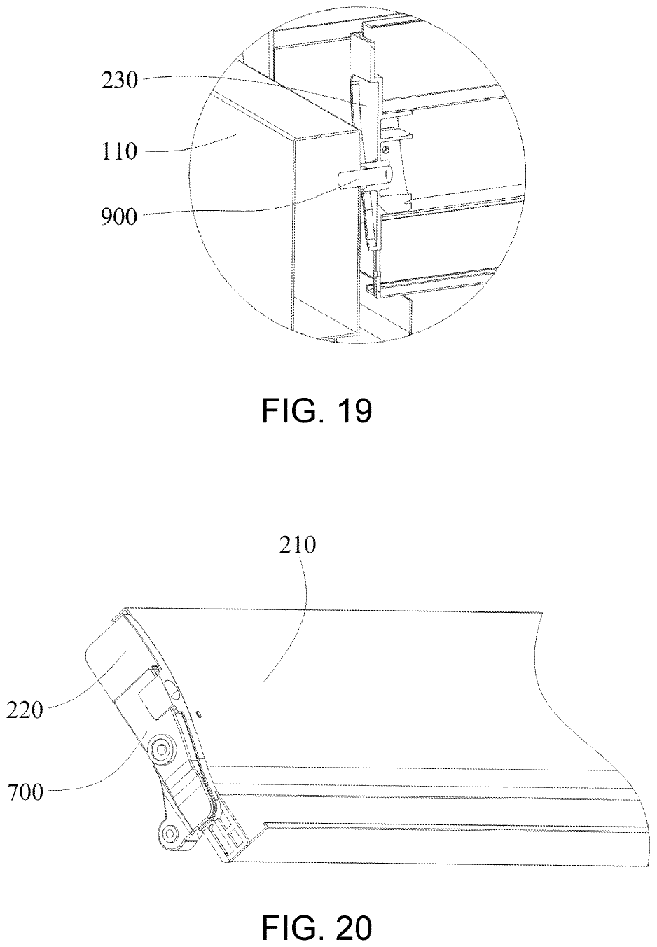

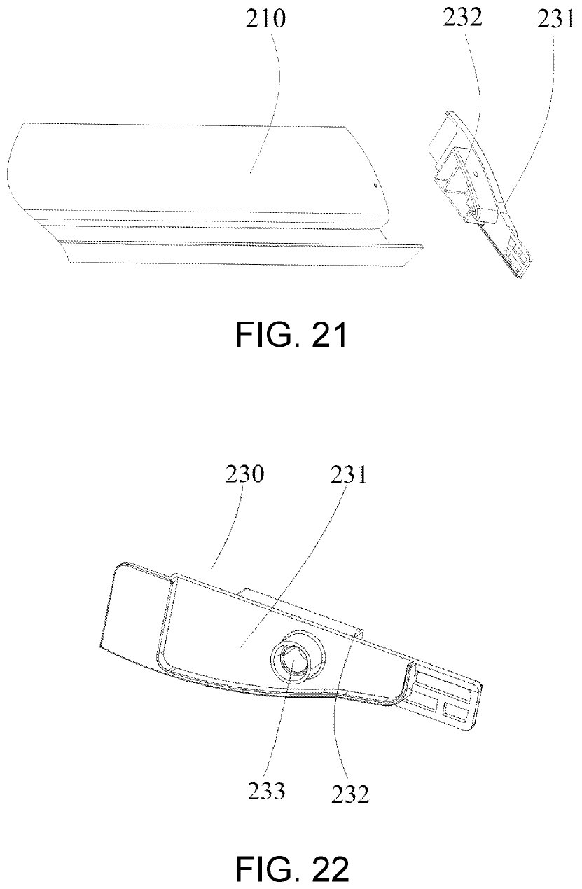

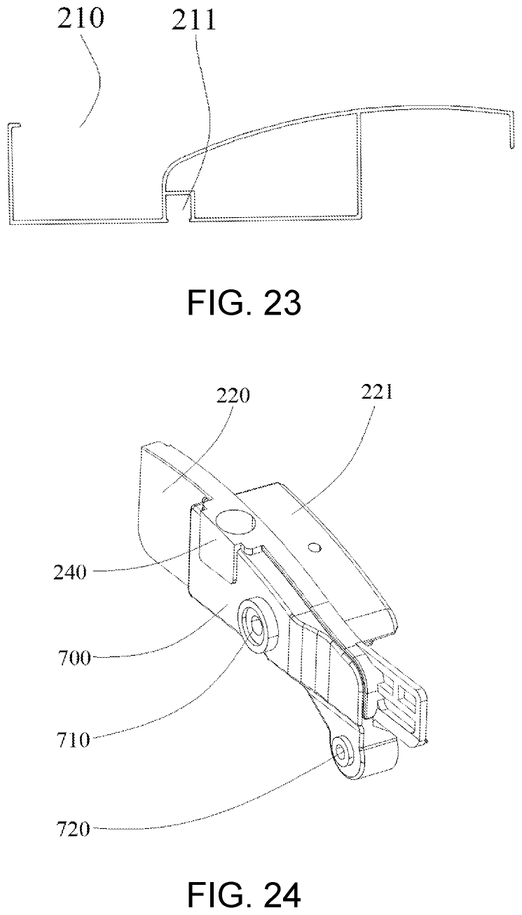

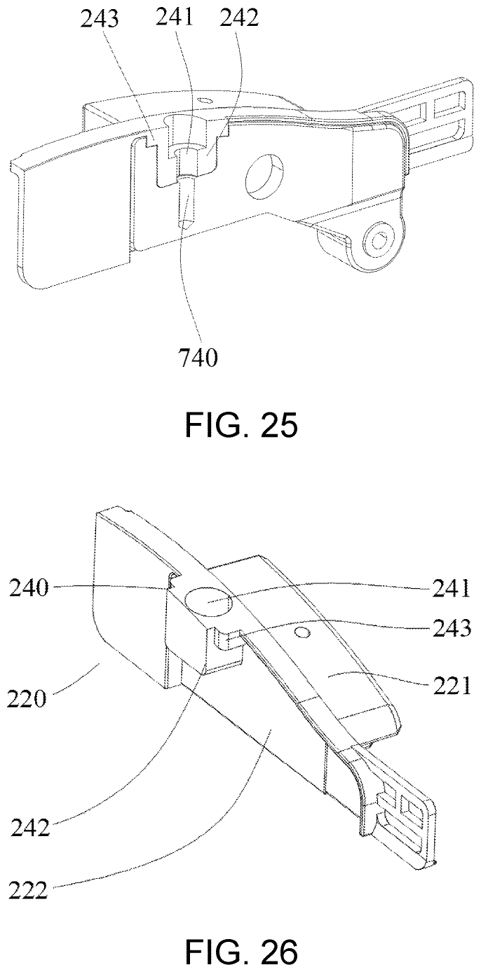

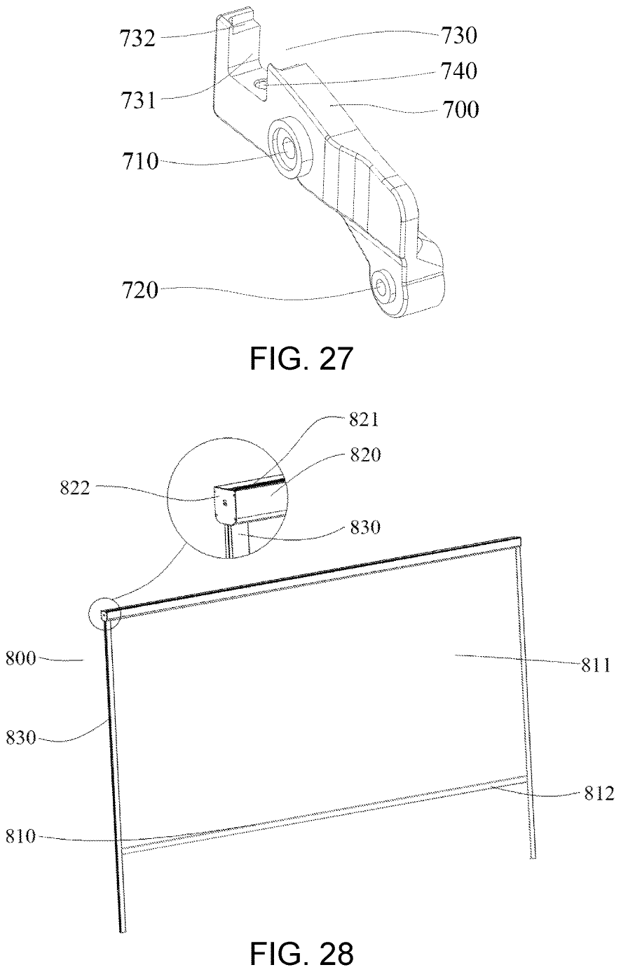

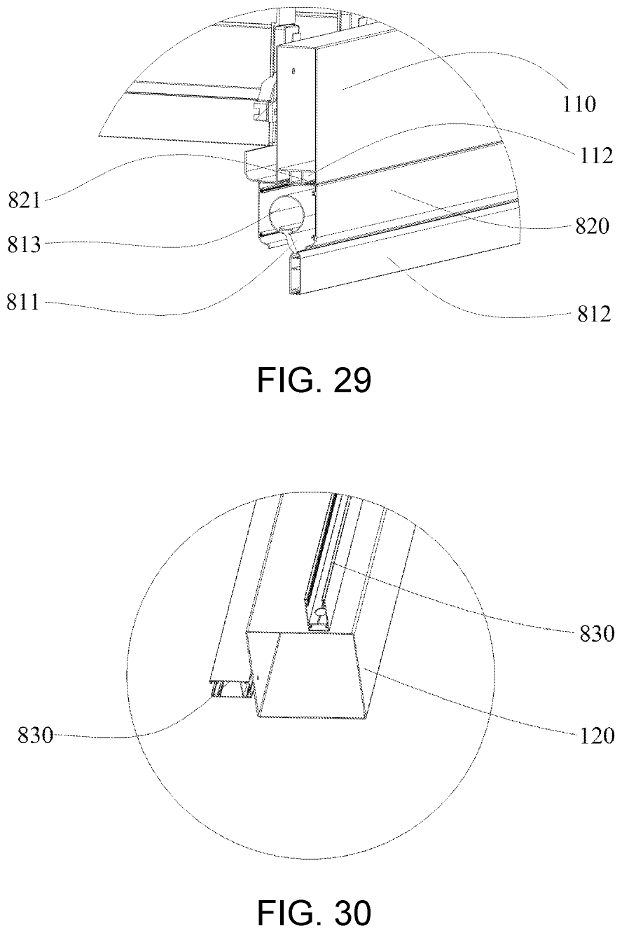

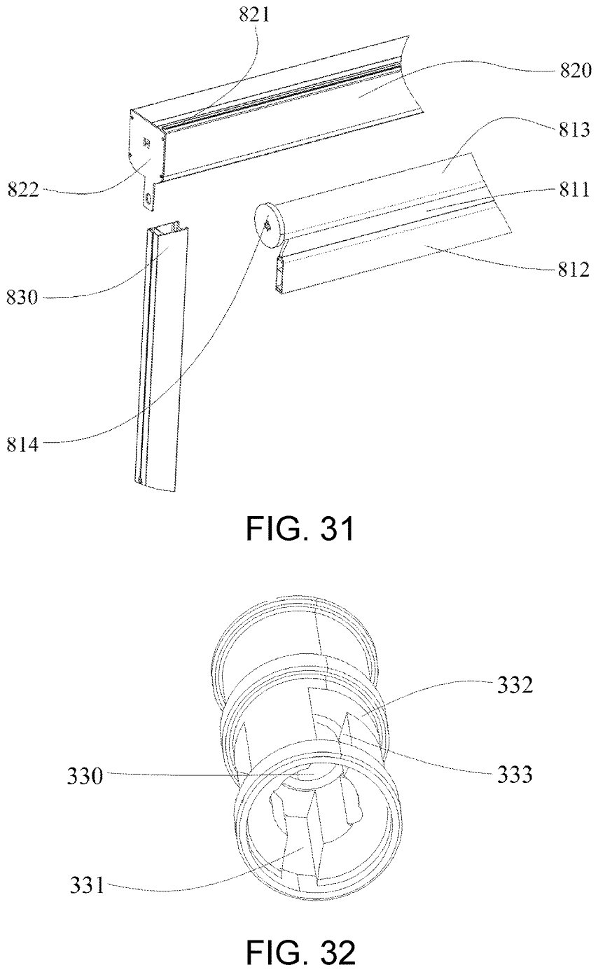

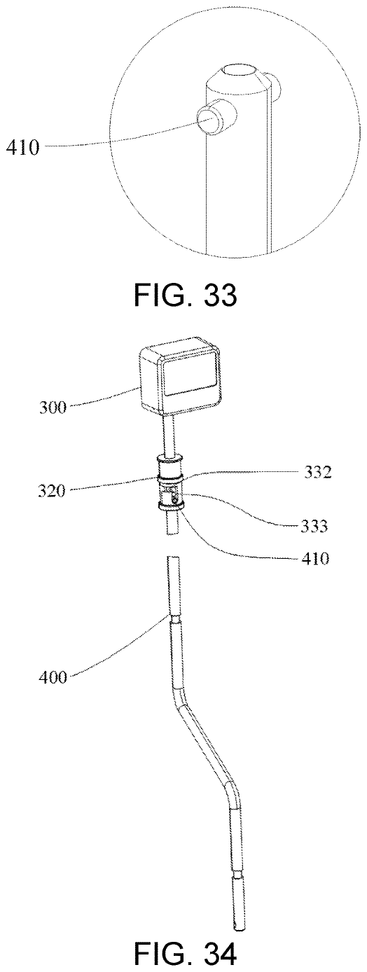

Based on Embodiment 1, as shown in FIG. 14 to FIG. 34, this embodiment discloses an outdoor louver tent, including a tent skeleton 100 and a louver tent roof 200. The louver tent roof 200 includes a plurality of louver board units. The louver tent roof 200 is configured to be fitted and mounted with a tent beam frame in the tent skeleton 100. Usually, the tent beam frame includes end edge tent beams and side edge tent beams 110. The end edge tent beams are usually parallel with the louver board units in the louver tent roof 200. Two ends of each of the louver board units are respectively configured to be fitted and mounted with the tent beam frame. Specifically, the two ends of the louver board unit are respectively fitted and mounted with the side edge tent beams 110.

Based on the above, the side edge tent beam 110 is provided with a plurality of rotating shaft holes 111 spaced apart along a length direction, and the rotating shaft hole 111 are each configured to be fitted and mounted with a louver rotating shaft 900 so as to realize a rotational fit, so that the louver board unit can flip and rotate.

Preferably, a bottom surface of the louver board 210 is provided with a light bar groove cavity 211. The light bar groove cavity 211 facilitates the assembly of the light bar so as to improve the lighting effect.

Based on the above, in a preferred embodiment, the tent skeleton 100 is further fitted with a roller shutter mechanism 800. The roller shutter mechanism 800 includes a roller shutter frame and roller shutters 810 disposed in the roller shutter frame, and the roller shutter frame is fitted and mounted with the tent skeleton 100. The roller shutter frame includes a side slide rail rack 830 and an upper roller shutter rack 820. The roller shutters 81 are rollable into the upper roller shutter rack. The roller shutter mechanism 800 is disposed on any one or more side surfaces in the tent skeleton 100. According to specifications of the tent skeleton 100, the tent skeleton may be disposed correspondingly. Moreover, according to use demands, the roller shutter mechanism may be assembled to one or more side surfaces.

In a specific structure, the side slide rail rack 830 is mounted on a side wall of a support column 120 in the tent skeleton 100. Usually, the fixed mounting is completed through fasteners, such as screws and bolts. Two ends of the upper roller shutter rack 820 are respectively fixedly fitted with the side wall of the support column 120 through a roller shutter end cover plate 822. A lower part of the roller shutter end cover plate 822 is clamped and embedded in the side slide rail rack 830 so as to improve the overall stability of mounting. A bottom of the tent beam frame is provided with mating grooves 112. Usually, the end edge tent beams and the side edge tent beams 110 are all provided with the mating grooves 112. An upper part of the upper roller shutter rack 820 is provided with mating strips 821. The mating strips 821 are fitted and mounted with the mating grooves 112, which improves the stability of assembling and mounting the upper roller shutter rack 820. Moreover, the corresponding fixed mounting can be completed through fasteners. The roller shutters 810 each include a roller shutter body 811, a roller shutter shaft 813, roller shutter mounting seats 814 located at two ends of the roller shutter shaft 813, and a roller shutter rod 812 located at a bottom end of the roller shutter body 811. The roller shutter mounting seats 814 are fitted and mounted with the roller shutter end cover plates 822. Two ends of the roller shutter rod 812 are usually fitted with slide rail grooves in the side slide rail rack 830, so that the roller shutter body 811 can be pulled up and down.

The louver board units each include a louver board 210, a first end cover 220 disposed at one end of the louver board 210, a second end cover 230 disposed at the other end of the louver board 210 and the louver rotating shaft 900 fitted with the tent beam frame. The first end cover 220 or/and the second end cover 230 is/are provided with a clamping seat 240. The clamping seat 240 is fixedly fitted with a linkage seat 700, and the linkage seat 700 is configured to be fitted and mounted with a linkage strip 600.One end of the linkage seat 700 is provided with a linkage shaft hole 720, and the linkage shaft hole 720 is fitted and mounted with the linkage strip 600 through a linkage rotating shaft, so that the linkage strip 600 can be linked with the plurality of louver board units to synchronously drive the plurality of louver board units.

In an embodiment, the linkage strip 600 is fitted with a linkage swing arm 500, the other end of the linkage swing arm 500 is driven to swing by a driving shaft 310, the driving shaft 310 is fitted and mounted with a turbine seat 300, and the turbine seat 300 is driven by an operating rod 400. As the operating rod 400 rotates, the turbine seat 300 drives the driving shaft 310 to rotate, the driving shaft 310 drives the linkage swing arm 500 to swing, the linkage swing arm 500 drives the linkage strip 600 to shift, and the linkage strip 600 drives the corresponding linkage seat 700 to move. By combining the rotational fit between the louver rotating shaft 900 and the side edge tent beam 110, the louver board 210 rotates to open or close.

In a specific structure, a lower part of the turbine seat 300 is fitted with a turbine drive seat 320, and the turbine drive seat 320 is configured to be fitted with the operating rod 400. The operating rod 400 drives the turbine drive seat 320 to rotate, and the turbine drive seat 320 drives the turbine seat 300 so as to drive the driving shaft 310 to rotate. A rod embedment groove 330 is provided in the turbine drive seat 320. The rod embedment groove 330 includes an entrance/exit groove 331, a transposition groove 332 and a limit groove 333, and an upper end of the operating rod 400 is provided with an embedment rod 410. The embedment rod 410 is capable of moving upward along the entrance/exit groove 331 into the limit groove 333 through the transposition groove 332, and then moving downward into the limit groove 333 such that the embedment rod 410 is fitted and embedded in the limit groove 333, thereby completing the rotational fit between the operating rod 400 and the turbine drive seat 320.

In an embodiment, the linkage strip 600 is fitted with the linkage swing arm 500, the other end of the linkage swing arm 500 is driven to swing by the driving shaft 310, and the driving shaft 310 is electrically driven by a motor.

Based on the above, in a preferred embodiment, the clamping seat 240 is disposed on the first end cover 220, and the first end cover 220 includes a first louver fixing portion 221, a first end cover portion 222 and the clamping seat 240 disposed on an outer side wall of the first end cover portion 222. The clamping seat 240 is provided with a clamping fixing hole 241. The linkage seat 700 is provided with a clamping groove 730. The clamping seat 240 is embedded in the clamping groove 730. An embedment fixing hole 740 is provided in the clamping groove 730. The clamping fixing hole 241 and the embedment fixing hole 740 are aligned with each other, so that the linkage seat 700 can be directly mounted to the first end cover 220. The mounting structure is simple and convenient, thereby reducing the difficulty of mounting and improving the efficiency of mounting. The linkage seat 700 is provided with a first louver shaft hole 710. One end of the louver rotating shaft 900 is fitted and mounted with the first louver shaft hole 710, and the other end of the louver rotating shaft 900 extends outwards to be fitted and mounted with the tent beam frame. The second end cover 230 includes a second louver fixing portion 231, a second end cover portion 232 and a second louver shaft hole 233. One end of the louver rotating shaft 900 is configured to be fitted and mounted with the second louver shaft hole 233, and the other end of the louver rotating shaft 900 extends outwards to be fitted and mounted with the tent beam frame.

In a specific mounting process, the first end cover 220 and the second end cover 230 are fitted and mounted to the two ends of the louver board 210, and the louver rotating shaft 900 in the second end cover 230 is assembled. Their preassembly usually has been completed. An outer end of the louver rotating shaft 900 is embedded into the rotating shaft hole 111 in the side edge tent beam 110. During the assembly of the other end, the linkage seat 700 is first mounted with the louver rotating shaft 900. Their preassembly usually has been completed. The louver rotating shaft 900 mounted on the linkage seat 700 is mounted to the rotating shaft hole 111 in the side edge tent beam 110 on the other side. Then, the fixed mounting of the whole louver board unit is realized directly by using the quick mounting structure of the linkage seat 700 and the first end cover 220, so that the louver board unit can be mounted to the side edge tent beam 110 more conveniently and effectively.

Based on the above, in a preferred embodiment, the second end cover 230 has a same structure as the first end cover 220, and the second end cover 230 is fitted and mounted with the linkage seat 700 through the clamping seat 240. The linkage seat 700 is provided with a first louver shaft hole 710. One end of the louver rotating shaft 900 is configured to be fitted and mounted with the first louver shaft hole 710, and the other end of the louver rotating shaft 900 extends outwards to be fitted and mounted with the tent beam frame.

In the specific mounting process, the first end cover 220 and the second end cover 230 are fitted and mounted to the two ends of the louver board 210. Their preassembly usually has been completed. In addition, the linkage seat 700 is mounted to the louver rotating shaft 900. Their preassembly usually has been completed. The louver rotating shaft 900 mounted on the linkage seat 700 is mounted to the rotating shaft hole 111 in the side edge tent beam 110. Then, the fixed mounting of the whole louver board unit is realized directly by using the quick mounting structure of the linkage seat 700, the first end cover 220 and the second end cover 230, so that the louver board unit can be mounted to the side edge tent beam 110 more conveniently and effectively.

Based on any of the above, in a specific structure, the clamping seat 240 includes a clamping seat body 242 and alignment seats 243 disposed at two sides of the clamping seat body 242, and the clamping groove 730 includes a clamping groove body 731 and alignment grooves 732 disposed at two sides of the clamping groove body 731. The clamping seat body 242 is correspondingly fitted with the clamping groove body 731, and the alignment seats 243 are correspondingly fitted with the alignment grooves 732. The clamping seat 240 is a convex structure, and the clamping groove 730 is a concave cavity. The structures of the clamping seat 240 and the clamping groove 730 are optimized, which facilitates the assembly and fixation of the linkage seat 700 and makes the mounting more stable and convenient.

The clamping seat 240 and the clamping groove 730 are interchangeable. The clamping groove 730 may be mounted in the first end cover 220 or/and the second end cover 230, and the clamping seat 240 may be mounted on the linkage seat 700.

In the present invention, by optimizing the design of the clamping seat, the linkage seat can be quickly fitted and mounted with the first end cover or/and the second end cover in the louver board, so that the louver board unit can be quickly assembled and mounted with the linkage strip, and conveniently fitted and mounted with the tent beam frame, thereby making the mounting more convenient.

1. A tent beam skeleton for outdoor louver tent, comprising a tent skeleton and a louver tent roof, the tent skeleton comprises a tent beam frame and a plurality of support columns for supporting the tent beam frame, and the louver tent roof is configured to be fitted with the tent beam frame; wherein the tent beam frame comprises end edge tent beams, side edge tent beams and fixed bases, the fixed bases being configured to connect the end edge tent beams and the side edge tent beams, each of the fixed bases being provided with vertical lock holes and horizontal lock holes, the vertical lock holes being provided in a mounting platform of the fixed base, the fixed base being provided with locking reinforcement seats, the horizontal lock holes being located in the locking reinforcement seats, and fasteners being respectively fixedly mounted to the vertical lock holes and the horizontal lock holes by running through the end edge tent beams and the side edge tent beams.

2. The tent beam skeleton for outdoor louver tent according to claim 1, wherein a lower part of the fixed base is provided with an embedment seat, and the embedment seat is fixedly mounted to an upper end of the support column; and an inner wall of the support column is provided with a reinforcing embedment groove and a reinforcing clamping strip, and the embedment seat is provided with an embedment clamping strip and an embedment clamping groove, the embedment clamping strip being configured to be fitted and mounted with the reinforcing embedment groove, and the embedment clamping groove being configured to be fitted and mounted with the reinforcing clamping strip.

3. The tent beam skeleton for outdoor louver tent according to claim 2, wherein the fixed base comprises a first side wall and a second side wall, and the first side wall and the second side wall are disposed adjacent to each other, opposite surfaces of the first side wall and the second side wall being respectively provided with a first tent beam groove and a second tent beam groove, and a limit boss being disposed between the first tent beam groove and the second tent beam groove.

4. The tent beam skeleton for outdoor louver tent according to claim 3, wherein inner side surfaces of the first side wall and the second side wall are respectively provided with the locking reinforcement seat, and the locking reinforcement seat is provided with at least two horizontal lock holes spaced apart along a vertical direction.

5. The tent beam skeleton for outdoor louver tent according to claim 4, wherein two ends of the side edge tent beam are respectively provided with a first tent beam mounting portion, and the first tent beam mounting portion is configured to be correspondingly fitted with the first tent beam groove, the first tent beam mounting portion being provided with first horizontal butting holes and first vertical butting holes, and the first horizontal butting holes and the first vertical butting holes being all through hole structures.

6. The tent beam skeleton for outdoor louver tent according to claim 5, wherein two ends of the end edge tent beam are respectively provided with a second tent beam mounting portion, and the second tent beam mounting portion is configured to be correspondingly fitted with the second tent beam groove, the second tent beam mounting portion being provided with second horizontal butting holes and second vertical butting holes, and the second horizontal butting holes and the second vertical butting holes being all through hole structures.

7. The tent beam skeleton for outdoor louver tent according to claim 6, wherein the side edge tent beam is provided with a first drainage groove, and the end edge tent beam is provided with a second drainage groove, end portions of the first drainage groove and the second drainage groove being adjacent to a water leakage opening in the mounting platform; and the side edge tent beam is provided with a mounting beam body, the mounting beam body being configured to be fitted and mounted with the louver tent roof.

8. The tent beam skeleton for outdoor louver tent according to claim 1, wherein the end edge tent beams or/and the side edge tent beams are each formed by butting two tent beam units, a butt joint of the two tent beam units being provided with a receiving base, one part of an inner cavity of the receiving base being in an inner cavity of the tent beam unit at one end, and the other part of the inner cavity being in an inner cavity of the tent beam unit at the other end.

9. The tent beam skeleton for outdoor louver tent according to claim 8, wherein the receiving base comprises a side receiving seat and an upper receiving seat, the side receiving seat being provided with a plurality of side fastening holes, the upper receiving seat being provided with a plurality of upper fastening holes, an end portion of the tent beam unit being provided with a receiving end, a side wall of the receiving end being provided with side butting holes, an upper surface of the receiving end being provided with upper butting holes, the side butting holes being configured to be correspondingly fitted with the side fastening holes, and the upper butting holes being configured to be correspondingly fitted with the upper fastening holes.

10. An outdoor louver tent, comprising the tent beam skeleton according to claim 1, wherein a louver tent roof comprises a plurality of louver board units, two ends of each of the louver board units being respectively configured to be fitted and mounted with the tent beam frame; and the louver board units each comprise a louver board, a first end cover disposed at one end of the louver board, a second end cover disposed at the other end of the louver board and a louver rotating shaft fitted with the tent beam frame, the first end cover or/and the second end cover being provided with a clamping seat, the clamping seat being fixedly fitted with a linkage seat, and the linkage seat being configured to be fitted and mounted with a linkage strip.

11. The outdoor louver tent according to claim 10, wherein the clamping seat is disposed on the first end cover, and the first end cover comprises a first louver fixing portion, a first end cover portion and the clamping seat disposed on an outer side wall of the first end cover portion, the clamping seat being provided with a clamping fixing hole, the linkage seat being provided with a clamping groove, the clamping seat being embedded in the clamping groove, an embedment fixing hole being provided in the clamping groove, and the clamping fixing hole and the embedment fixing hole being aligned with each other.

12. The outdoor louver tent according to claim 10, wherein the linkage seat is provided with a first louver shaft hole, one end of the louver rotating shaft being fitted and mounted with the first louver shaft hole, and the other end of the louver rotating shaft extending outwards to be fitted and mounted with the tent beam frame.

13. The outdoor louver tent according to claim 12, wherein the second end cover comprises a second louver fixing portion, a second end cover portion and a second louver shaft hole, one end of the louver rotating shaft being configured to be fitted and mounted with the second louver shaft hole, and the other end of the louver rotating shaft extending outwards to be fitted and mounted with the tent beam frame.

14. The outdoor louver tent according to claim 12, wherein the second end cover has a same structure as the first end cover, and the second end cover is fitted and mounted with the linkage seat through the clamping seat.

15. The outdoor louver tent according to claim 10, wherein a bottom surface of the louver board is provided with a light bar groove cavity.

16. The outdoor louver tent according to claim 10, wherein the tent skeleton is further fitted with a roller shutter mechanism, the roller shutter mechanism comprising a roller shutter frame and roller shutters disposed in the roller shutter frame, and the roller shutter frame being fitted and mounted with the tent skeleton; and the roller shutter frame comprises a side slide rail rack and an upper roller shutter rack, the roller shutters being rollable into the upper roller shutter rack.

17. The outdoor louver tent according to claim 16, wherein the side slide rail rack is mounted on a side wall of a support column in the tent skeleton, and two ends of the upper roller shutter rack are respectively fixedly fitted with the side wall of the support column through a roller shutter end cover plate; and a bottom of the tent beam frame is provided with mating grooves, and an upper part of the upper roller shutter rack is provided with mating strips, the mating strips being fitted and mounted with the mating grooves.

18. The outdoor louver tent according to claim 16, wherein the roller shutters each comprise a roller shutter body, a roller shutter shaft, roller shutter mounting seats located at two ends of the roller shutter shaft, and a roller shutter rod located at a bottom end of the roller shutter body, the roller shutter mounting seats being fitted and mounted with the roller shutter end cover plates.

19. The outdoor louver tent according to claim 10, wherein the clamping seat comprises a clamping seat body and alignment seats disposed at two sides of the clamping seat body, and the clamping groove comprises a clamping groove body and alignment grooves disposed at two sides of the clamping groove body, the clamping seat body being correspondingly fitted with the clamping groove body, and the alignment seats being correspondingly fitted with the alignment grooves.

20. The outdoor louver tent according to claim 19, wherein one end of the linkage seat is provided with a linkage shaft hole, the linkage shaft hole is fitted and mounted with the linkage strip through a linkage rotating shaft, the linkage strip is fitted with a linkage swing arm, the other end of the linkage swing arm is driven to swing by a driving shaft, and the driving shaft is fitted and mounted with a turbine seat or a motor.

21. (canceled)

22. (canceled)
